(19) United States
(12) Patent Application Publication
(10) Pub. No.: US 2009/0060287 A1
(43) Pub. Date: Mar. 5, 2009

(54) Physiological condition measuring device

(76) Inventors: Roderick A. Hyde, Redmond, WA (US); Muriel Y. Ishikawa, Livermore, CA (US); Jordin Kare, Seattle, WA (US); Eric C. Leuthardt, St. Louis, MO (US); Royce A. Levien, Lexington, MA (US); Lowell L. Wood, JR., Bellevue, WA (US); Victoria Y.H. Wood, Livermore, CA (US); Dennis J. Rivet, Portsmouth, VA (US)

Correspondence Address: IV - SUITER SWANTZ PC LLO, 14301 FNB PARKWAY , SUITE 220, OMAHA, NE, 68154, US

(21) Appl. No.: 11/899,606

(22) Filed: Sep. 5, 2007

(51) Int. Cl. G06K 9/00

(52) U.S. Cl. 382/118

(57) ABSTRACT

A device is configured for one or more of communication transfer and audio/video playback. The device includes a sensing system for measuring a physiological condition through manipulation of an output of the device and analysis of a user response.

### BACKGROUND

Portable electronic devices have become ubiquitous in modern society. Because of the rapid and increasing miniaturization of components, such devices have become increasingly sophisticated. However, such devices fail to measure health conditions of a user.

Often, the only measurement of a health condition for a user occurs in an annual examination before a medical provider. Many people would benefit from periodic monitoring of physiological characteristics that may have an impact on their health. Other users may desire information regarding monitoring their progress regarding a health-related condition.

### SUMMARY

A device is configured for one or more of communication transfer and audio/video playback. The device includes a sensing system for measuring a physiological condition through manipulation of an output of the device and analysis of a user response.

A communication device may include a housing, a processing unit enclosed by the housing, and an image capture device for capturing an image. The image capture device is electrically coupled to the processing unit. The communication device is configured for measuring a physiological condition by analyzing an image captured by the image capture device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a communication device including a processing unit and an image capture device.

FIG. 2 is a schematic of a cellular telephone.

FIG. 3 is a schematic of a Personal Digital Assistant (PDA).

FIG. 4 is a schematic of a portable video game player.

FIG. 5 is a schematic of a portable audio player.

FIG. 6 is a schematic of a cellular telephone, wherein the cellular telephone is configured to recognize facial features.

FIG. 7 is a schematic of a cellular telephone, wherein the cellular telephone is configured to perform a retinal scan.

FIG. 8 is a schematic of a cellular telephone, wherein the cellular telephone is configured to perform a transdermal scan.

FIG. 9 is a schematic of a cellular telephone, wherein the cellular telephone includes a motion detection device.

FIG. 10 is a schematic of a geographical area, wherein a device moves from a first geographical position to a second geographical position.

FIG. 11 is a schematic of a cellular telephone, including text output on a display.

FIG. 12 is a schematic of a cellular telephone, including text output by a visual projection device included with the cellular telephone.

FIG. 13 is a schematic of a timeline illustrating reaction times of a user.

FIG. 14 is a schematic of a timeline illustrating measurements taken according to a pseudorandom time scheme.

FIG. 15 is a schematic of a timeline illustrating measurements taken during an availability window and subsequent to a measurement request.

The use of the same symbols in different drawings typically indicates similar or identical items, unless context dictates otherwise.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

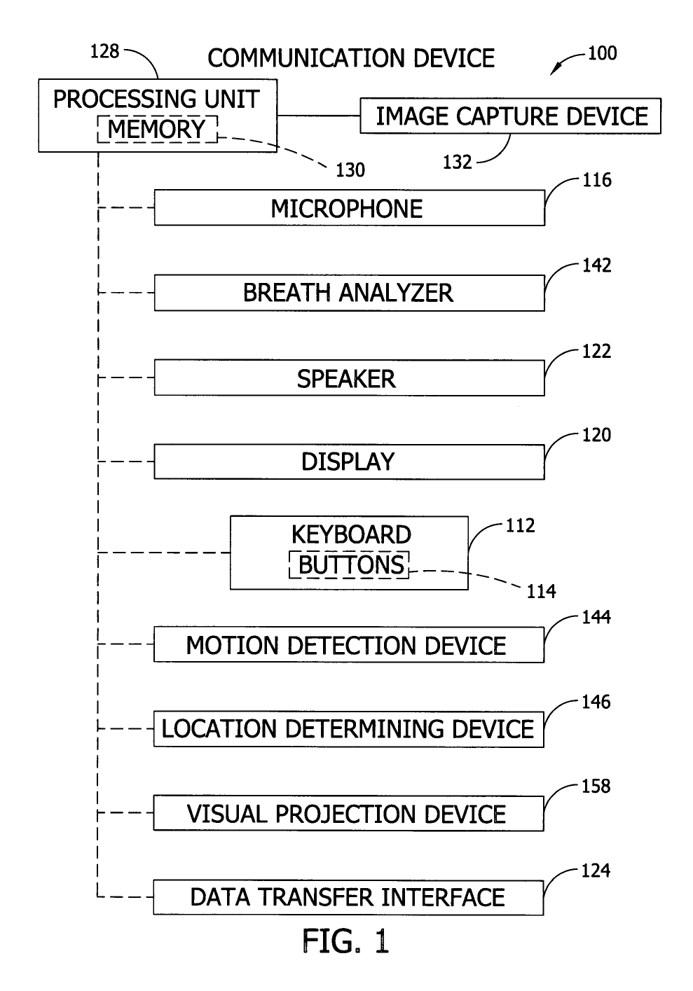

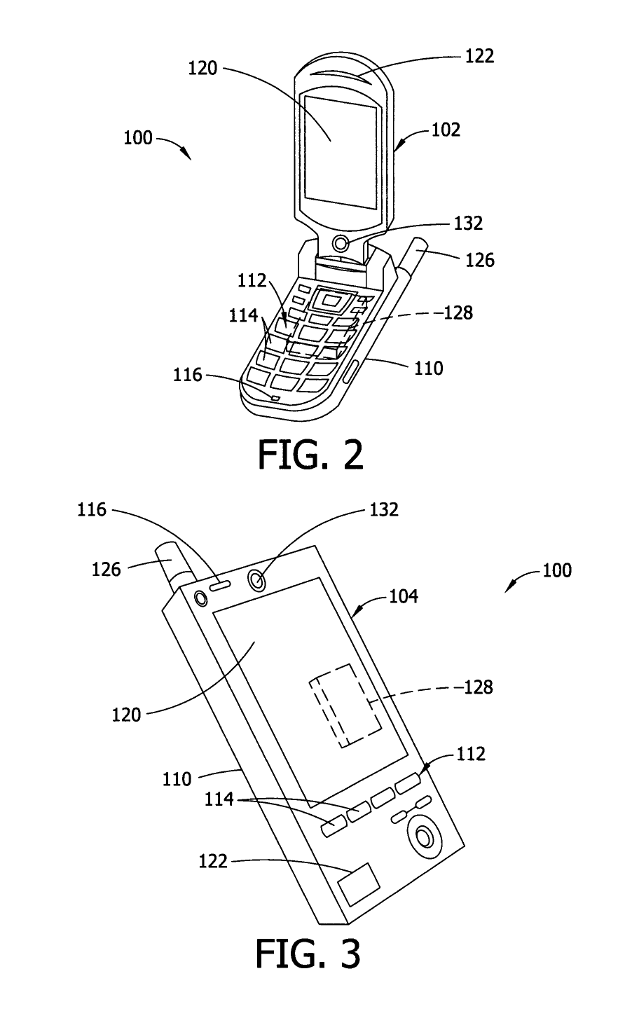

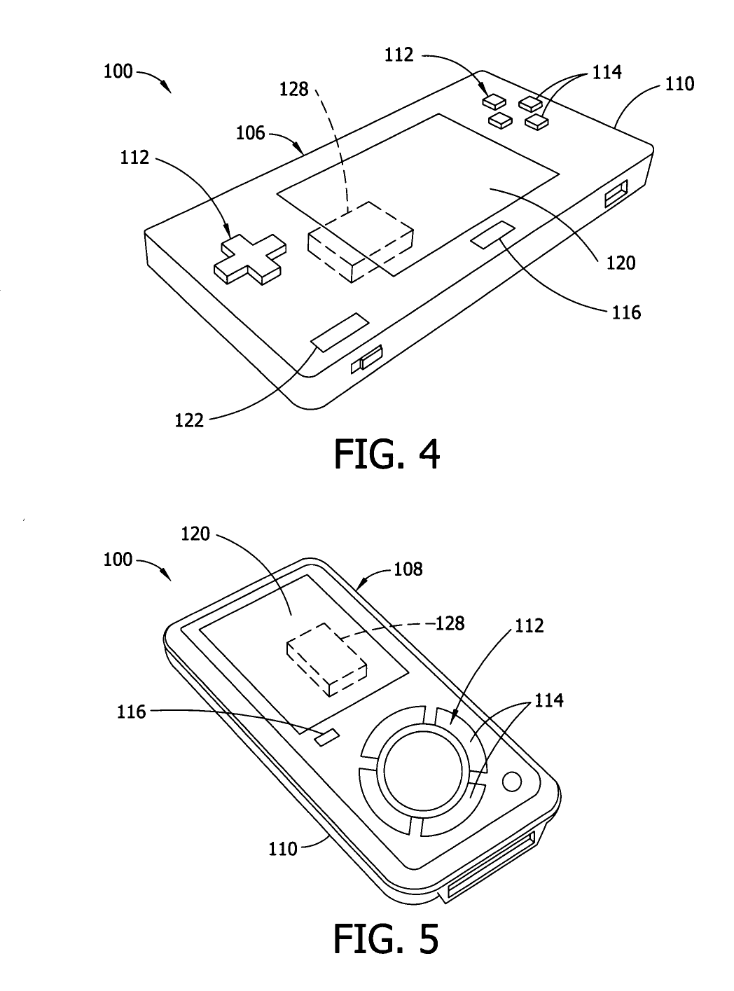

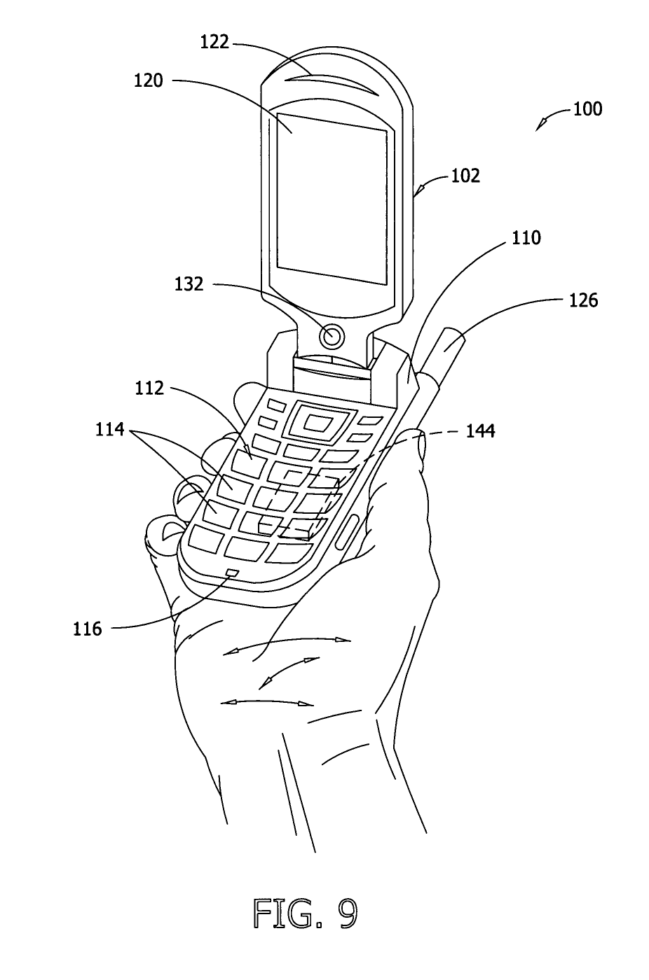

Referring generally to FIGS. 1 through 15, a device 100 is illustrated. The device 100 may comprise a cellular telephone 102 (e.g., FIG. 2), a personal digital assistant (PDA) 104 (e.g., FIG. 3), a portable game player 106 (e.g., FIG. 4), a portable audio player 108 (e.g., FIG. 5), or another type of device, such as an iPod marketed by Apple Inc. in Cupertino, Calif. The device 100 generally represents instrumentality for user-based interaction. User-based interaction may be implemented electronically, e.g., with an electronic circuit and/or another set of electrical connections for receiving an input (such as a user-generated command) and providing an output (such as an audio, video, or tactile response). An electronic circuit may comprise an Integrated Circuit (IC), such as a collection of interconnected electrical components and connectors supported on a substrate. One or more IC's may be included with the device 100 for accomplishing a function thereof.

The device 100 may comprise a printed circuit board having conductive paths superimposed (printed) on one or more sides of a board made from an insulating material. The printed circuit board may contain internal signal layers, power and ground planes, and other circuitry as needed. A variety of components may be connected to the printed circuit board, including chips, sockets, and the like. It will be appreciated that these components may be connected to various types and layers of circuitry included with the printed circuit board.

The device 100 may include a housing 110, such as a protective cover for at least partially containing and/or supporting a printed circuit board and other components that may be included with the device 100. The housing 110 may be formed from a material such as a plastic material comprising a synthetic or semi-synthetic polymerization product. Alternatively, the housing 110 may be formed from other materials, including rubber materials, materials with rubber-like properties, and metal. The housing 110 may be designed for impact resistance and durability. Further, the housing 110 may be designed for being ergonomically gripped by the hand of a user.

The device 100 may be powered via one or more batteries for storing energy and making it available in an electrical form. Alternatively, the device 100 may be powered via electrical energy supplied by a central utility (e.g., via AC mains). The device 100 may include a port for connecting the device to an electrical outlet via a cord and powering the device 100 and/or for charging the battery. Alternatively, the device 100 may be wirelessly powered and/or charged by placing the device in proximity to a charging station designed for wireless power distribution.

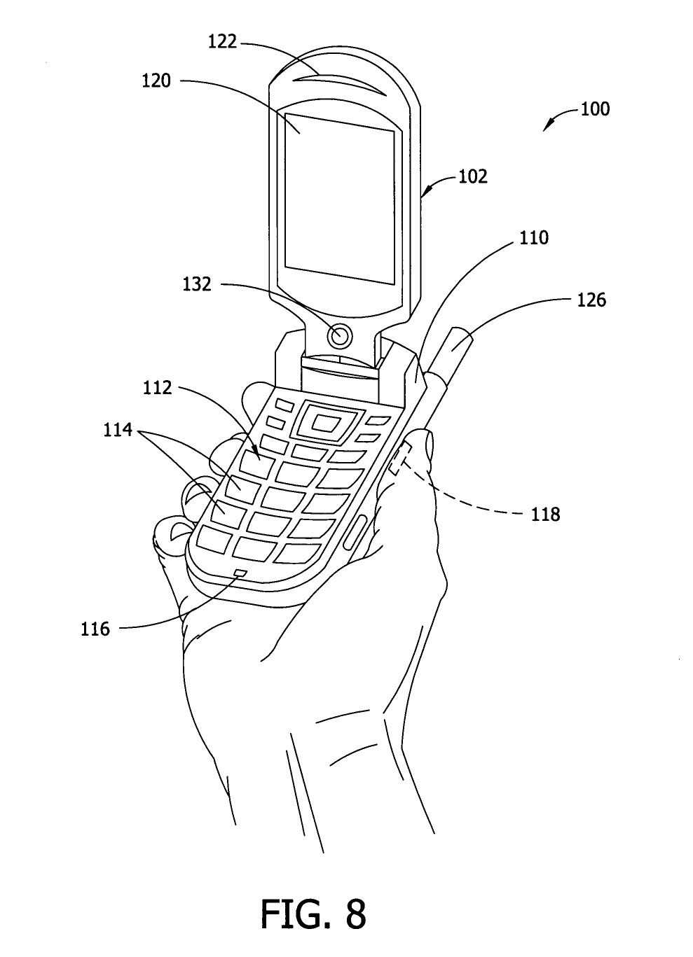

User-based interaction may be implemented by utilizing a variety of techniques. The device 100 may comprise a keyboard 112 (e.g., FIG. 2, FIG. 4, FIG. 5, etc.) including a number of buttons. The user may interact with the device by pressing a button 114 (e.g., FIG. 2, FIG. 3, FIG. 4, FIG. 5 etc.) to operate an electrical switch, thereby establishing an electrical connection in the device 100. The user may issue an audible command or a command sequence to a microphone 116 (e.g., FIG. 3). The device 100 may comprise a sensor 118 (e.g. FIG. 8) for measuring a physiological condition. Sensor 118 may include an electrode. Sensor 118 may measure cardiac signals, pulmonary signals, neurologic signals and chemical signals. Cardiac signals may include electrocardiographic signals. Electrocardiographic (ECG) signals may indicate potential cardiac events, such as myocardial ischemia/infarction or cardiac arrhythmias. Pulmonary signals may include oxygen levels, respiration rate, and blood gas levels. Neurologic signals may include electroencephalogic (EEG) signals. Chemical signals may include skin ph levels, perspiration chemistry in addition to breath chemicals measured by breath analyzer 142 (e.g. FIG. 1). Headphones, operatively couplable with device 100, may be utilized to acquire signals, such as electroencephalogic (EEG) signals. It is appreciated that sensor 118 may comprise an electrically conductive element placed in contact with body tissue for detecting electrical activity and/or for delivering electrical energy (e.g., FIG. 8).

User-based interaction may be facilitated by providing tactile feedback to the user. The device 100 may include various electrical and/or mechanical components for providing haptic feedback, such as the feeling of a button press on a touch screen, variable resistance when manipulating an input device (e.g., a joystick/control pad), and the like. The device 100 may provide feedback by presenting data to the user in visual form via a display 120 (e.g., FIG. 2, FIG. 3, FIG. 4, FIG. 5, etc.), in audible form via a speaker 122 (e.g., FIG. 2, FIG. 3, FIG. 4, FIG. 5, etc.), and with other audio/visual playback mechanisms as desired.

The display 120 may comprise a Liquid Crystal Display (LCD), a Light Emitting Diode (LED) display, an Organic Light Emitting Diode (OLED) display, a Cathode Ray Tube (CRT) display, a fiber optic display, and other display types. It will be appreciated that a variety of displays may be utilized to present visual information to a user as desired. Similarly, a variety of mechanisms may be utilized to present audio information to the user of the device 100. The speaker 122 may comprise a transducer for converting electrical energy (e.g., signals from an electronic circuit) into mechanical energy at frequencies around the audible range of a user.

The device 100 may comprise a communication device configured for communication transfer. The communication device may be utilized to facilitate an interconnection between the user and one or more other parties. The communication device may provide for the transmission of speech data between the user and another individual by converting speech to an electric signal for transmission from one party to another. The communication device may provide for the transmission of electronic data between the device 100 and another device by transmitting data in the form of an electric signal from one device to another. The communication device may connect with another party and/or another device via a physical connection and/or via a wireless connection.

The communication device may connect with another party or another device via a physical interconnection outlet, e.g., a telephone jack, an Ethernet jack, or the like. Alternatively, the communication device may connect with another party and/or another device via a wireless connection scheme, e.g., utilizing a wireless network protocol, radio transmission, infrared transmission, and the like. The device 100 may include a data transfer interface 124 (e.g. FIG. 1) for connecting to one or more parties utilizing either a physical connection or a wireless connection. The data transfer interface 124 may comprise a physical access point, such as an Ethernet port, a software-defined transmission scheme, such as executable software for formatting and decoding data transmitted and received, as well as other interfaces for communication transfer as desired.

It is contemplated that device 100 may be utilized for the transfer of physiological data of a user. Transmitted data may be encrypted or pass code protected to prevent the unauthorized access to transmitted data whereby only authorized personnel may access the transmitted data. Encryption may refer to a process, executed by processing unit 128, whereby data is mathematically-jumbled causing the data to be unreadable unless or until decrypted, typically through use of a decryption key.

The device 100 may include an antenna 126 for radiating and/or receiving data in the form of radio energy. The antenna 126 may be fully or partially enclosed by the housing 110, or external to the housing 110. The device 100 may utilize the antenna 126 to transmit and receive wirelessly over a single frequency in the case of a half-duplex wireless transmission scheme, or over more than one frequency in the case of a full-duplex wireless transmission scheme. The antenna may be constructed for efficiently receiving and broadcasting information over one or more desired radio frequency bands. Alternatively, the device 100 may include software and/or hardware for tuning the transmission and reception of the antenna 126 to one or more frequency bands as needed.

The device 100 may broadcast and/or receive data in an analog format. Alternatively, the device 100 may broadcast and/or receive data in a digital format. The device 100 may include analog-to-digital and/or digital-to-analog conversion hardware for translating signals from one format to another. Additionally, the device 100 may include a Digital Signal Processor (DSP) for performing signal manipulation calculations at high speeds. A processing unit 128 (e.g., FIG. 1, FIG. 2, etc.) may be included with the device 100 and at least substantially enclosed by the housing 110. The processing unit 128 may be electrically coupled with the microphone 116, the speaker 122, the display 120, the keyboard 112, and other components of the device 100, such as the data transfer interface 124. The processing unit may comprise a microprocessor for receiving data from the keyboard 112 and/or the microphone 116, sending data to the display 120 and/or the speaker 122, controlling data signaling, and coordinating other functions on a printed circuit board.

The processing unit 128 may be capable of transferring data relating to the status of a user (e.g., a measurement of a physiological condition). The device 100 may be connected to a variety of transmitting and receiving devices operating across a wide range of frequencies. The device 100 may be variously connected to a number of wireless network base stations. Alternatively, the device 100 may be variously connected to a number of cellular base stations. In this manner, the device 100 may be able to establish and maintain communication transfer between the user and one or more other parties while the device 100 is geographically mobile. The processing unit 128 may command and control signaling with a base station. The communication device may transmit and receive information utilizing a variety of technologies, including Frequency Division Multiple Access (FDMA), Time Division Multiple Access (TDMA), and Code Division Multiple Access (CDMA). The communication device may comprise a variety of telephony capable devices, including a mobile telephone, cellular telephone 102, a pager, a telephony equipped hand-held computer, personal digital assistant (PDA) 104, and other devices equipped for communication transfer.

The device 100 may include a variety of components for information storage and retrieval, including Random Access Memory (RAM), Read Only Memory (ROM), Electrically Erasable Programmable Read Only Memory (EEPROM), and programmable nonvolatile memory (flash memory). The processing unit 128 may be utilized for controlling data storage and retrieval in the memory of the device 100. The processing unit 128 may also be utilized for formatting data for transmission between the device 100 and one or more additional parties. The processing unit 128 may comprise memory 130 (e.g., FIG. 1), such as the storage and retrieval components described. The memory 130 may be provided in the form of a data cache. The memory 130 may be utilized to store data relating to the status of a user (e.g., a measurement of a physiological condition). The memory 130 may be utilized for storing instructions executable by the processing unit 128. Such instructions may comprise a computer program native to the device 100, software acquired from a third party via the data transfer interface 124, as well as other instructions as desired.

It is contemplated that processing unit 128 and memory 130 may include security features to prevent the unauthorized disclosure of physiological data for assurance of privacy for a user. For example, data may be encrypted or pass code protected to allow access to only designated personnel. Additionally, physiological data may be partitioned into various security levels whereby various levels of access may be presented, including open access, pre-selected individuals and emergency contacts.

The device 100 may comprise an image capture device, such as a camera 132 (e.g., FIG. 2, FIG. 3, etc.) for capturing a single image (e.g., a still image) or a sequence of images (e.g., a movie). The image capture device may be electrically coupled to the processing unit 128 for receiving images. An image captured by the camera 132 may be stored by the information storage and retrieval components of the device 100 as directed by the processing unit 128. An image may be converted into an electric signal and transmitted from one party to another via an interconnection between the user and one or more other parties (e.g., via a physical or wireless connection).

The device 100 may be equipped for measuring a physiological condition. The measurements may be performed in the background without explicit user commands. Further, the measurements may be performed in a passive manner (e.g., without user instructions and/or without a user's knowledge) or in an active manner (e.g., according to user instructions and/or with a user's knowledge). A physiological measurement may be utilized for making a determination about the status of a user (e.g., a user's health and/or well-being). Alternatively, a physiological measurement may be utilized for directing functioning of the device 100. For instance, in the case of the cellular telephone 102, the act of raising the volume of a user's voice may trigger a response from the telephone. The response may comprise raising the volume of audio provided by the speaker 122. It will be appreciated that physiological measurements taken by the device 100 in either an active manner or a passive manner may be utilized for a variety of purposes.

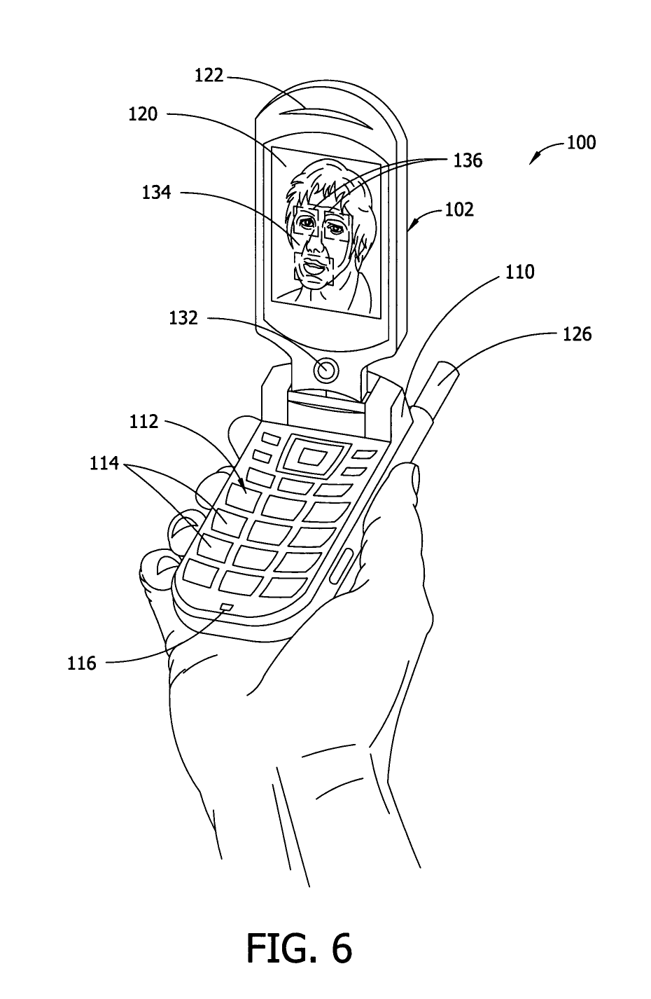

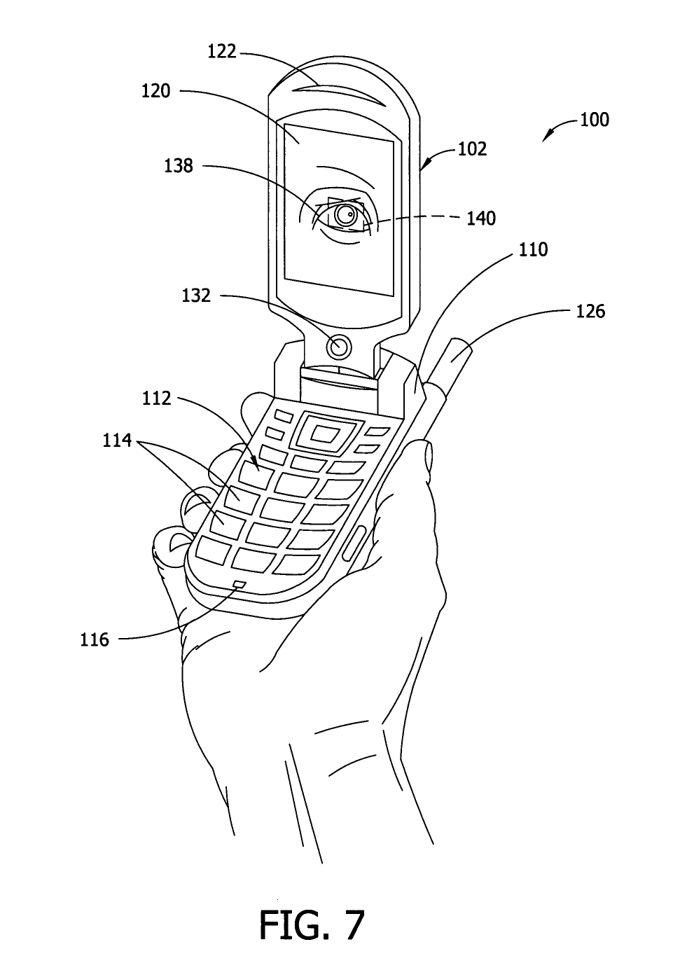

An image capture device, such as the camera 132 may be utilized to capture an image 134 of the user. The camera 132 may then provide the image 134 (e.g., FIG. 6) to the processing unit 128, which may analyze the image. The processing unit 128 may analyze the image 134 utilizing a variety of optical measurement techniques. For example, optical measurements may be taken of various facial features 136 for facial recognition. Alternatively, the camera 132 may be utilized to capture an image 138 (e.g., FIG. 6) of a user's eye. The processing unit 128 may analyze the image 138 and perform a retinal scan 140 (e.g., FIG. 7) of the of the user's eye.

The recognition of facial features and the retinal scan may be utilized for a variety of purposes, including identification of the user and/or monitoring of the user's status (e.g., the user's overall health and/or well-being). For instance, images 134 and 138 may be examined for various shapes and sizes (e.g., mole and/or birthmark dimensions), tones and hues (e.g., skin color/pallor), and other characteristics indicative of a user's status. It will be appreciated that the forgoing list is exemplary and explanatory only, and images captured by the image capture device may be analyzed to identify any physiological state or condition having visually identifiable features.

Sensor 118 may be coupled with the processing unit 128 for performing a transdermal measurement through or by way of the skin. Alternatively, another type of device may be utilized for performing such a measurement. These transdermal measurements may be utilized for determining the amount of perspiration of a user, determining the health of a user's nervous system, and for other purposes as needed. Further, it will be appreciated that other equipment may be utilized for taking a measurement through the user's skin. A needle may be utilized to probe a user for a blood sample to determine a blood sugar level. Alternatively, a probe may be utilized to test the sensitivity of the user to a touch stimulus.

The microphone 116 may be utilized for measuring a user's vocal output and/or the surroundings of the user to determine the user's status. For example, the user's voice may be analyzed for voice recognition (i.e., to determine the identity of the user). Alternatively, the microphone 116 may be utilized for providing the processing unit 128 with audio data from a user to measure a physiological condition. For instance, the microphone 116 may be utilized for measuring a user's vocal output to determine the mood of the user. A warning may be issued to the user if the user's overall mood is determined to be contrary to a known or predicted health condition. For example, a user suffering from high blood pressure may be warned of undue exertion if a vocal stress determination is found to be at a dangerous level. In another instance, the microphone 116 may be utilized for measuring a user's audio output to determine a user's level of respiration (e.g., a breathing rate).

Alternatively, the microphone 116 may be utilized to collect information about a user's surroundings in an effort to identify the user's environment and/or characteristics thereof. The device 100 may report such characteristics to the user, or to another party as desired. It will be appreciated that the microphone 116 may be utilized to collect a variety of physiological and environmental data regarding a user. Further, it will be appreciated that the processing unit 128 may analyze this data in a number of different ways, depending upon a desired set of information and/or characteristics.

The device 100 may be equipped with a breath analyzer 142 (e.g., FIG. 1) a microfluid chip) electrically coupled to the processing unit 128. The breath analyzer 142 may be utilized for receiving and analyzing the breath of a user. For example, the breath analyzer 142 may be utilized for sampling a user's breath to determine/measure the presence of alcohol on the user's breath. The processing unit 128 may then analyze measurements taken by the breath analyzer 142 to determine a blood-alcohol level for the user. The device 100 may be utilized to report on a level of alcohol as specified for a particular user (e.g., an unsafe and/or illegal level). Further, the breath analyzer 142 may be utilized for other purposes as well, including detecting the presence of chemicals, viruses, and/or bacteria on a user's breath. Other characteristics of the user's breath may be monitored and reported on as well, including temperature, moisture content, and other characteristics.

The device 100 may be equipped with a motion detection device 144 (e.g., FIG. 1, FIG. 2) electrically coupled to the processing unit 128. The motion detection device 144 may comprise an accelerometer, or another device for detecting and measuring acceleration, vibration, and/or other movements of the device 100. When the device 100 is held or retained by the user, movements of the user may be measured by the accelerometer and monitored by the processing unit 128. The processing unit 128 may be utilized to detect abnormal movements, e.g., seizures, tremors that may be indicative of Parkinson's disease, and the like. Device 100, in the form of a game playing device, may include a motion device for detection of an epileptic seizure of a user while using the device 100, such as playing a video game. The processing unit 128 may also be utilized to detect information regarding a user's motion, including gait, and stride frequency (e.g., in the manner of a pedometer).

Alternatively, the processing unit 128 may be utilized to detect abnormal movements comprising sudden acceleration and/or deceleration indicative of a movement that may be injurious to the user. For example, violent deceleration could be indicative of a car accident, while sudden acceleration followed by an abrupt stop could be indicative of a fall. It will be appreciated that the aforementioned scenarios are exemplary and explanatory only, and that the motion detection device 144 may be utilized to monitor many various characteristics relating to the motion of a user and/or device 100. Further, it will be appreciated that any abnormal activity or motion, or lack of motion for a period of time, may be reported to a third party, including a family member (e.g., in the case of a fall), a safety monitoring service, or another agency.

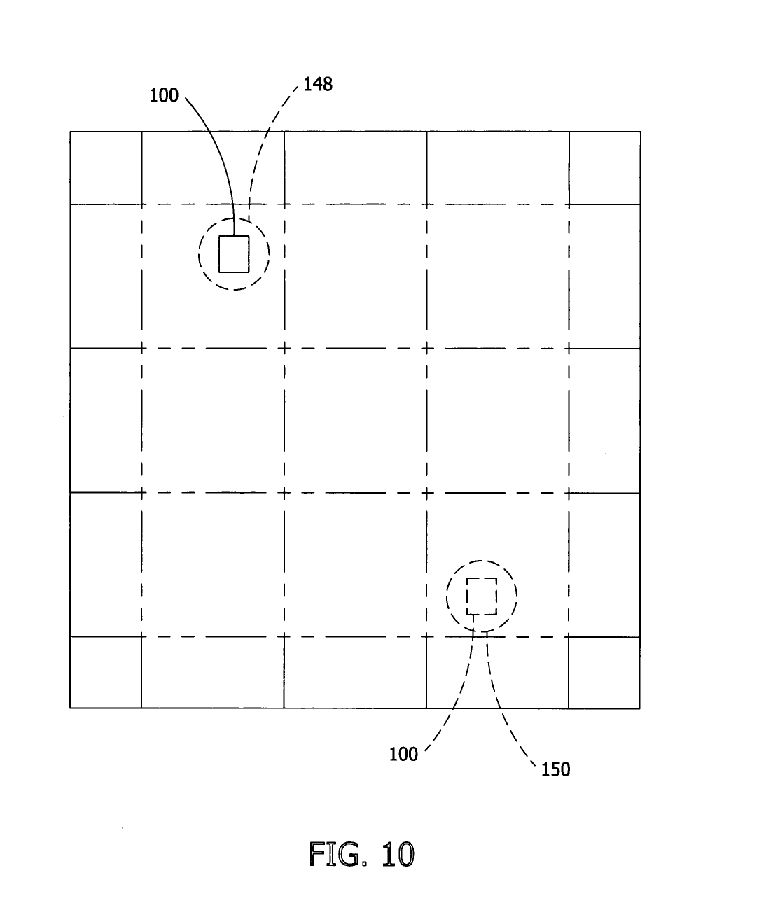

The device 100 may be equipped with a location determination device 146 electrically coupled to the processing unit 128. The location determination device 146 (e.g., FIG. 1) may comprise instrumentality for determining the geographical position of the device 100. The location determination device 146 (e.g., FIG. 1) may comprise a Global Positioning System (GPS) device, such as a GPS receiver. A GPS receiver may be utilized to monitor the movement of a user. For example, as illustrated in FIG. 10, the device 100 may be in first vicinity 148 at a first time, and in second vicinity 150 at a second time. By reporting the position of the device 100 to the processing unit 128, the device 100 may be able to monitor the movement of a user.

In one example, the user's movement may be examined to determine the distance the user has traveled from the first vicinity 148 to the second vicinity 150 while engaging in exercise, such as distance running. In this instance, the device 100 may report data of interest to the user, such as calories burned, or the like. In another instance, a user's lack of movement over time may be monitored. In this instance, an alert message may be delivered to the user (e.g., a wake up call) or to a third party (e.g., a health monitoring service) when movement of the user ceases (or is substantially limited) for a period of time.

In one instance, the device 100 may comprise a sensing system for measuring a physiological condition through manipulation of an output of the device 100 and analysis of a user response. In another instance, the device 100 may comprise a sensing system for measuring a physiological condition/response to an output of the device 100 and analysis of a user response. Device 100 may cause manipulation of an output of device 100 to measure a physiological condition/response of a user. Manipulation of an output of device 100 may include change of an output, adjustment of an output, and interaction with a user. It will be appreciated that measurement of a user response may include active measurement of a physiological condition through analysis of a response to device output variance and passive measurement of a physiological condition by a sensor associated with device 100. The sensing system may comprise medical sensors that are integral to the device 100. A user may request that the device 100 utilize the sensing system to perform a physiological measurement. Alternatively, the device 100 may perform a measurement surreptitiously. It will be appreciated that a number of requested and/or surreptitious measurements may be taken over time, and the results may be analyzed to determine patterns and signs of a user's status that would not otherwise be readily apparent. Further, measurements may be taken based upon a user's history. A variety of information gathering and statistical techniques may be utilized to optimize the gathering of such information and its subsequent analysis. It will be appreciated that the device 100 may utilize a variety of techniques to establish the identity of a user in relation to the gathering of such information. Once the identity of a user has been established, the device may record and monitor data appropriately for that user.

The device 100 may retain separate sets of information for a variety of users. Further, it is contemplated that the device 100 may correlate information about a particular user to information about other users in a related grouping (e.g., other user's having a familial relationship). This related information may be collected by the device 100 when it is utilized by more than one party. For example, a number of children in a family may share a telephone. If the telephone identifies one of the children as having a fever, it may report that information to the family, as well as monitoring and reporting that the other two children do not have a fever. It will be appreciated that such a report may comprise information regarding the timing of the measurements, and the expected accuracy (confidence interval) of the measurements. It is contemplated that time histories may be developed and viewed on the device 100 and/or transmitted off the device 100 as needed.

It is contemplated that information about a user may be collected by another device. Further, data from another device may be transmitted to the device 100 and analyzed by the processing unit 128. External data may be analyzed in comparison with measurements taken by the device 100. External data may also be analyzed in view of a known or suspected user status as determined by the device 100. For example, information regarding a user's heart rate may be compared with information about the user's respiration collected by the device 100 and/or information inferred about the user's heart based on a physiological measurement collected by the device 100. Alternatively, the data from the device 100 may be uploaded to a central authority for comparison with data measured by other devices for the same user, for related users (e.g., family), or for entirely unrelated users, such as to establish health trends for a population, or the like.

The device 100 may be utilized to measure the hearing capability of a user. The speaker 122 may be utilized for providing various auditory cues to the user. Thus, the hearing capability of a user may be measured through manipulation of a volume of an audio output of the device 100. For example, in the case of the cellular telephone 102, the volume of the telephone's ring may be adjusted until the user responds to the ring volume. Alternatively, the hearing capability of a user may be measured through manipulation of a frequency of an audio output of the device 100. For example, in the case of the cellular telephone 102, the frequency of the telephone's ring may be adjusted until the user responds to the ring frequency. The manipulation of the ring volume and the ring frequency are explanatory only and not meant to be restrictive. It is contemplated that the output of the speaker 122 may be adjusted in a variety of ways, and various responses of a user may be interpreted in a variety of ways, in order to determine information about the user's status.

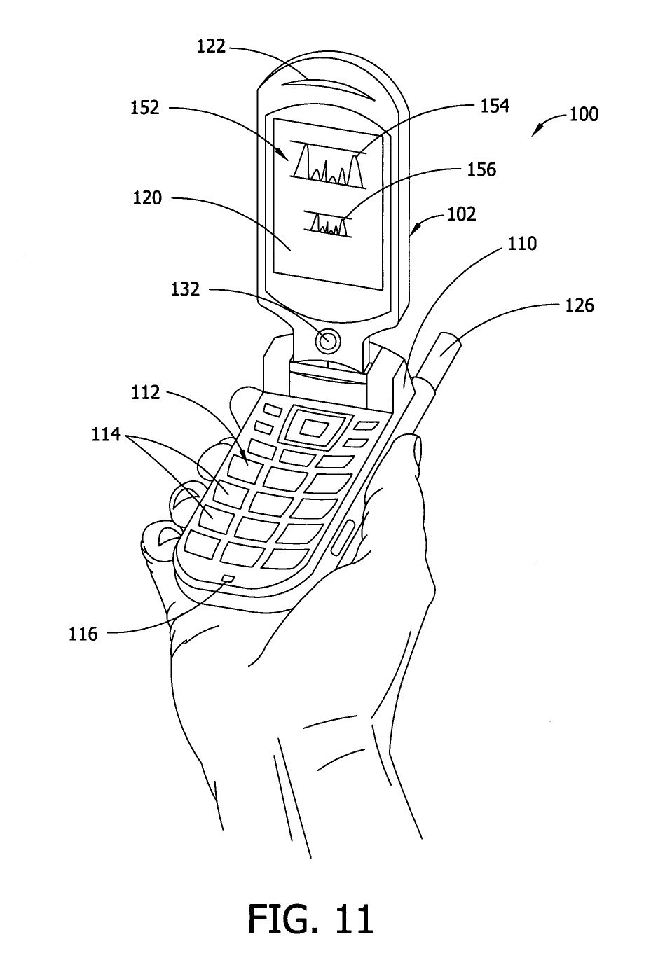

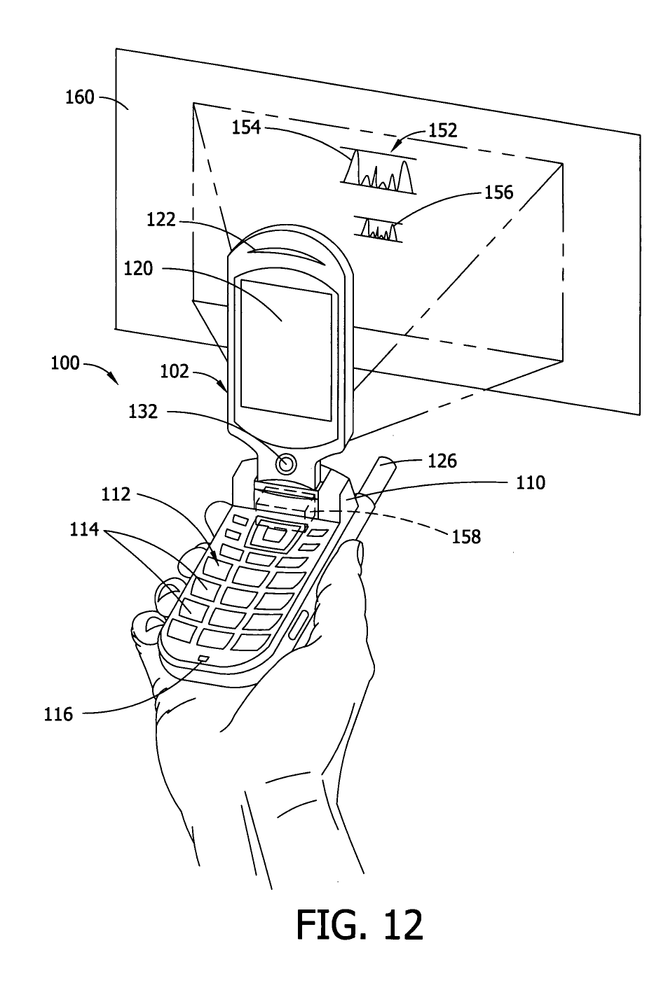

The device 100 may be utilized to measure the vision capability of a user. The display 120 may be utilized for providing various visual cues to the user. A font size of a text output 152 (e.g., FIG. 11, FIG. 12) of the device 100 may be manipulated to measure the vision capability of the user. For example, text may be provided at a first text size 154. If the user is capable of reading the first text size 154 (e.g., FIG. 11), the size may be adjusted to a second text size 156 (e.g., FIG. 12). The second text size 156 may be smaller than the first text size 154. The text size may be adjusted until the user can no longer read the text with at least substantial accuracy. This information may be utilized to make a determination regarding the visual abilities of the user.

Alternatively, the processing unit 128 may be electrically coupled to a visual projection device 158 (e.g., FIG. 12). The visual projection device 158 may be configured for projecting an image (e.g., the text output 152 of the device 100) onto a surface 160 (e.g., as in FIG. 12 which may be a wall/screen). The vision capability of a user may be measured through manipulation of the image upon the surface 160. For example, text may be alternatively provided at a first text size 154 and a second text size 156 as previously described. It will be appreciated that the device 100 may measure the distance of the user away from the device 100 and/or the surface 160, (e.g., utilizing the camera 132). Alternatively, a user may inform the device of the distance. Further, the device 100 may provide a user with a desired distance and assume the user is at that distance. Any one of the aforementioned distance measurements/estimates may be factored into a determination of the vision capability of a user.

The text output 152 of the device 100 may comprise labels for graphical buttons/icons provided on the display 120 (e.g., in an example where the display 120 comprises a touch screen). In one instance, the size of the text comprising the labels on a touch screen is adjusted to measure a user's vision by recording how accurate the user is at identifying the graphical buttons/icons. In another instance, the text output 152 of the device 100 comprises an OLED label displayed on a button 114, and the text size of the button's label is adjusted through the OLED's output to measure the user's vision by recording how accurately button presses are made at various text sizes. In another example, the labels and/or on-screen placement for graphical buttons/icons may be altered in a pseudorandom fashion to prevent the user from memorizing the position of various labels/icons (e.g., in the case of testing visual recognition of various text sizes) and/or to test a user's mental acuity at identifying graphical buttons/icons at various and changing locations.

Alternatively, the text output 152 of the device 100 may comprise labels for graphical buttons/icons projected by the visual projection device 158 upon a work surface (e.g., a desk at which a user may sit). The device 100 may utilize the camera 132 or another device to record a user's motion proximal to a graphical button/icon projected by the visual projection device 158. The size of the text comprising the labels on the projected image may be adjusted to measure a user's vision by recording how accurate the user is at identifying the graphical buttons/icons, as previously described. Further, the locations of the graphical buttons/icons may be altered in a pseudorandom fashion as previously described.

Various data recorded about the user's recognition of the text output 152 may be reported to the processing unit 128, and the processing unit 128 may make a determination about the user's vision utilizing a variety of considerations as required (e.g., the distance of the user from the device 100 as previously described). Further, it will be appreciated that other various symbols and indicia besides text may be utilized with the display 120 and/or the buttons 114 to measure the vision capability of a user, including placing lines of varying lengths, thicknesses, and/or angles on the display 120 as needed.

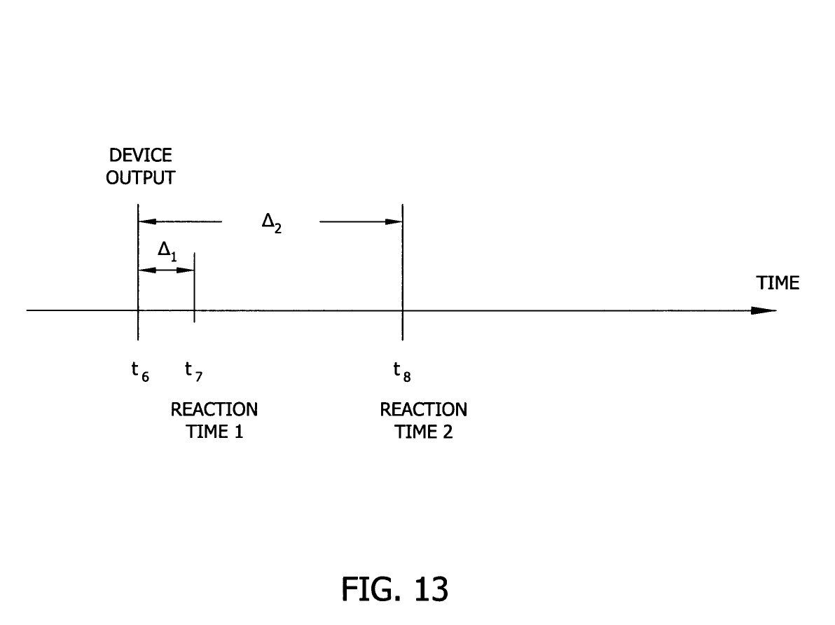

The device 100 may be utilized to measure the dexterity and/or reaction time of a user. The dexterity of a user may be measured through manipulation of the device 100 via a user input. For example, the processing unit 128 may be configured for measuring the dexterity of a user by examining characteristics of a depression of a button 114 (e.g., measurements of button press timing). In one instance, illustrated in FIG. 13, the device 100 provides the user with an output at time t₆, such as an audio cue provided by the speaker 122, a visual cue provided by the display 120, or another type of output as needed. The user may respond at a time t₇, providing a first reaction time Δ₁ between the cue and the response. Alternatively, the user may respond at time t₈, providing a second reaction time Δ₂ between the cue and the response. A reaction time of the user may be monitored to gather information about the status of the user. This information may be collected over time, or collected during a group of measurements during a period of time. An increase or decrease in a reaction time may be utilized to infer information about the user's status.

The device 100 may be utilized to measure characteristics of a user's memory. For example, a user's memory capability may be measured by the device 100. The device may store information known to a user at a certain point in time (e.g., information input or studied by the user). The information may then be stored in the memory 130 for subsequent retrieval. Upon retrieving the information, the processing unit 128 may provide questions/clues regarding the information to the user utilizing any of the devices that may be connected thereto. The user may then be prompted to supply the information to the device. By comparing user responses to the information stored in the memory 130, the device 100 may be able to make a determination regarding the memory capability of the user. This information may be collected over time, or collected during a group of measurements during a period of time. Further, the device 100 may be utilized to measure mental and/or physical characteristics by measuring how quickly tasks are completed on the device (e.g., typing a phone number) and/or external to the device (e.g., traveling from one location to another).

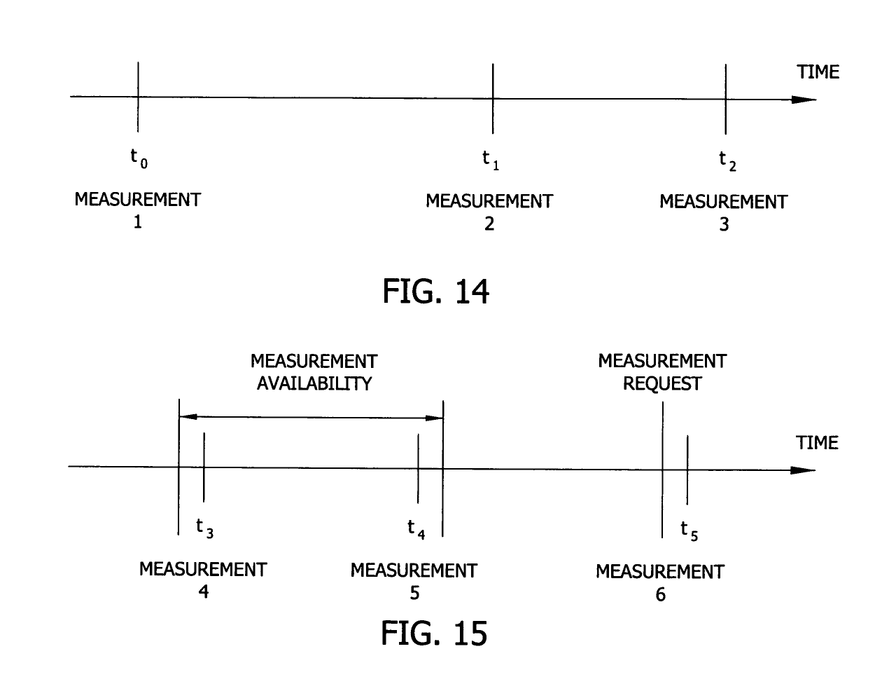

Referring now to FIG. 14, measurements of a user's status may be taken according to a pseudorandom time scheme, or according to another technique for providing measurements at variously different time intervals. A first measurement may be taken at time t₀, a second measurement may be taken at time t₁, and a third measurement may be taken at time t₂. Times t₀, t₁, and t₂ may be separated by variously different time intervals according to a pseudorandom time scheme (e.g., a sequence of numbers that appears random but may have been generated by a finite computation). The processing unit 128 may measure the status of a user (e.g., a measurement of a physiological condition) through any one of the various components connected to it as described herein. The processing unit 128 may generate a sequence of pseudorandom numbers. Alternatively, the device 100 may receive a randomized seed or a sequence of pseudorandom numbers from an external source, which may utilize an environmental factor, or the like, to compute the random seed or the pseudorandom sequence.

Referring now to FIG. 15, measurements of a user's status may be taken when available/opportunistically (i.e., when the device is held in a user's hand, when the device is open and aimed at a user's face, when the device is close to a user, when the device is close to a user's heart, when the device is gripped in a certain way). A fourth measurement may be taken at time t₃ and a fifth measurement may be taken at time t₄. The fourth and fifth measurements may comprise measuring a user's heart rate when the user is gripping the device 100. Times t₃ and t₄ may be separated by variously different time intervals according to a pseudorandom time scheme as previously described. However, times t₃ and t₄ are both within a measurement availability window. The measurement availability may be determined by the device 100 (e.g., measurements are taken when the device is in an “on” state as opposed to an “off” state). Alternatively, a user (either the user of the device 100 or another party) may determine the measurement availability. The processing unit 128 may measure the status of a user (e.g., a measurement of a physiological condition) through any one of the various components connected to it as described herein.

Alternatively, measurements of a user's status may be taken when requested. A sixth measurement may be taken at time t₅. Time t₅ may be subsequent to a measurement request. Time t₅ may be separated from the measurement request by variously different time intervals according to a pseudorandom time scheme as previously described. Alternatively, time t₅ may be determined by the device 100 (e.g., a measurement is taken when scheduled by the processing unit 128). It will be appreciated that a user (either a user of the device 100 or another party) may request the measurement. The processing unit 128 may measure the status of a user (e.g., a measurement of a physiological condition) through any one of the various components connected to it as described herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically matable and/or physically interacting components and/or wirelessly interactable and/or wirelessly interacting components and/or logically interacting and/or logically interactable components.

In some instances, one or more components may be referred to herein as “configured to” Those skilled in the art will recognize that “configured to” can generally encompass active-state components and/or inactive-state components and/or standby-state components, etc. unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. An apparatus, comprising:
a device, said device configured for at least one of communication transfer or audio/video playback, said device including a sensing system for measurement of a physiological condition through manipulation of an output of said device and analysis of a user response.

2-19. (canceled)

20. A communication device, comprising:
a housing;
a processing unit enclosed by said housing; and
an image capture device for capturing an image, said image capture device being coupled to said processing unit, wherein said communication device is configured for measurement of a physiological condition by analysis of said image.

21. The communication device as claimed in claim 20, wherein said image capture device is a camera.

22. The communication device as claimed in claim 20, wherein said processing unit is configured to recognize facial features.

23. (canceled)

24. (canceled)

25. The communication device as claimed in claim 20, further comprising a microphone electrically coupled to said processing unit.

26. The communication device as claimed in claim 25, wherein said processing unit is configured for measuring a physiological condition based upon audio received by said microphone.

27. The communication device as claimed in claim 26, wherein said processing unit is configured to determine an identity of a user based upon said audio received by said microphone.

28. The communication device as claimed in claim 20, further comprising a breath analyzer electrically coupled to said processing unit.

29. The communication device as claimed in claim 28, wherein said breath analyzer is configured to analyze breath of a user.

30. (canceled)

31. The communication device as claimed in claim 20, further comprising a speaker electrically coupled to said processing unit.

32. The communication device as claimed in claim 31, wherein said processing unit is configured to measure a hearing capability of a user.

33. The communication device as claimed in claim 32, wherein said processing unit is configured to measure said hearing capability is operably coupled with circuitry for manipulation of a volume of an audio output supplied by said speaker.

34. The communication device as claimed in claim 33, wherein said circuitry for manipulation of a volume of an audio output supplied by said speaker comprises:
circuitry for adjusting a ring volume to determine a level of volume in which said user responds to a ring.

35. The communication device as claimed in claim 32, wherein said processing unit configured to measure said hearing capability is operably coupled with circuitry for manipulation of a frequency of audio output supplied by said speaker.

36. The communication device as claimed in claim 35, wherein said circuitry for manipulation of a frequency of audio output supplied by said speaker comprises:
circuitry for adjusting a ring frequency to determine a frequency level in which said user responds to a ring.

37. The communication device as claimed in claim 20, further comprising a display electrically coupled to said processing unit.

38. The communication device as claimed in claim 37, wherein said processing unit is configured to measure a vision capability of a user.

39. The communication device as claimed in claim 38, wherein said processing unit configured to measure a vision capability of a user comprises:
said processing unit configured to measure said vision capability of said user operably coupled with circuitry for manipulation of a font size of a text output on said display.

40. The communication device as claimed in claim 20, further comprising a keyboard.

41. The communication device as claimed in claim 40, wherein said keyboard includes a plurality of buttons.

42. The communication device as claimed in claim 41, wherein said processing unit is configured to measure a dexterity of a user.

43. The communication device as claimed in claim 42, wherein said processing unit is configured to measure depression of one of said plurality of buttons by said user.

44. The communication device as claimed in claim 20, further comprising a motion detection device electrically coupled to said processing unit.

45. The communication device as claimed in claim 44, wherein said motion detection device is an accelerometer.

46. The communication device as claimed in claim 44, wherein said motion detection device is configured to measure a tremor measurement of a user.

47. The communication device as claimed in claim 44, wherein said processing unit is configured for determining a fall of a user through motion detected by said motion detection device.

48. The communication device as claimed in claim 20, further comprising a location determination device electrically coupled to said processing unit.

49. The communication device as claimed in claim 48, wherein said location determination device is a global positioning system receiver.

50. The communication device as claimed in claim 48, wherein said processing unit is configured to monitor movement of a user and is operably coupled with said location determination device.

51. The communication device as claimed in claim 50, wherein said processing unit is configured to deliver an alert message when movement of said user ceases for a designated period.

52. The communication device as claimed in claim 20, further comprising a visual projection device electrically coupled to said processing unit.

53. The communication device as claimed in claim 52, wherein said visual projection device is configured for projecting an image onto a surface.

54. The communication device as claimed in claim 53, wherein said processing unit is configured to measure a vision capability of a user.

55. The communication device as claimed in claim 54, wherein said processing unit configured to measure a vision capability of a user comprises:
circuitry for manipulation of said image on said surface operably coupled with said processing unit configured to measure said vision capability of said user.

56. (canceled)

57. (canceled)

58. (canceled)

59. The communication device as claimed in claim 20, wherein said processing unit comprises a memory.

60. The communication device as claimed in claim 59, wherein said memory stores data relating to measurement of said physiological condition.

61. The communication device as claimed in claim 20, wherein said processing unit is configured to transfer data relating to measurement of said physiological condition.

62. (canceled)

63. (canceled)

64. (canceled)

65. The communication device as claimed in claim 60, wherein said processing unit is configured to encrypt data relating to measurement of said physiological condition stored in said memory.

66. The communication device as claimed in claim 63, wherein said processing unit is configured to encrypt transferred data.

67. The communication device as claimed in claim 51, wherein said processing unit is configured to encrypt said alert message.

68. A communication device, comprising:
a housing;
a processing unit enclosed by said housing; and
a sensor electrically coupled to said processing unit for measuring a first physiological condition, wherein said communication device is configured for measurement of a second physiological condition through manipulation of an output of said device and analysis of a user response.

69-75. (canceled)

76. An apparatus, comprising:
a device, said device configured for at least one of communication transfer or audio/video playback, said device including a sensing system for measurement of a physiological condition to an output of said device and analysis of a user response.
